(19) United States
(12) Patent Application Publication
(10) Pub. No.: US 2026/0193030 A1
(43) Pub. Date: Jul. 9, 2026

(54) GRABBER ARM CONTROL SYSTEM

(71) Applicant: Oshkosh Corporation, Oshkosh, WI (US)

(72) Inventors: Jeff Meyer, Oshkosh, WI (US); Leo Van Kampen, Conestogo (CA); Nicholas Weykamp, Oshkosh, WI (US); Jacob Wallin, Oshkosh, WI (US); Thomas Vale, Oshkosh, WI (US); Vince Andrada, Oshkosh, WI (US); Todd Cannon, Oshkosh, WI (US); Joseph Wigle, Oshkosh, WI (US); Umang Patel, Oshkosh, WI (US); Brian Brost, Oshkosh, WI (US); Quincy Wittman, Oshkosh, WI (US); Andy Cornelius, Oshkosh, WI (US); Vince Schad, Oshkosh, WI (US); John Bonczyk, Oshkosh, WI (US)

(73) Assignee: Oshkosh Corporation, Oshkosh, WI (US)

(21) Appl. No.: 19/439,154

(22) Filed: Jan. 2, 2026

Related U.S. Application Data
(60) Provisional application No. 63/741,694, filed on Jan. 3, 2025.

(51) Int. Cl. B65F 3/02

(52) U.S. Cl. CPC B65F 3/02; B65F 2003/023

(57) ABSTRACT

One embodiment of the present disclosure relates to a refuse vehicle. The refuse vehicle includes a body, a grabber assembly coupled to the body and including an actuator, a sensor coupled to at least one of the body or the grabber assembly to generate sensor data indicative of a position of a refuse container, a user interface, and a control system communicably coupled to the sensor and the user interface. The control system may determine, based on the sensor data, an operation of the grabber assembly corresponding to at least one of the refuse container or an obstacle proximate to the refuse container, present, via the user interface, an indicator of the operation including a request for an operator acknowledgement of the operation, receive the operator acknowledgement of the operation, and operate, responsive to receiving the operator acknowledgement, the actuator of the grabber assembly to complete the operation.

### CROSS REFERENCE TO RELATED APPLICATIONS

This application claims the benefit of and priority to U.S. Provisional Patent Application No. 63/741,694, filed Jan. 3, 2025, the entire contents of which are hereby incorporated by reference herein.

### BACKGROUND

The present disclosure generally relates to the field of refuse vehicles and systems for depositing refuse into refuse vehicles.

### SUMMARY

One embodiment of the present disclosure relates to a refuse vehicle. The refuse vehicle includes a body, a grabber assembly coupled to the body and including an actuator, and a sensor coupled to at least one of the body or the grabber assembly to generate sensor data indicative of a position of a refuse container. The refuse vehicle may include a user interface and a control system communicably coupled to the sensor and the user interface. The control system may determine, based on the sensor data, an operation of the grabber assembly corresponding to at least one of the refuse container or an obstacle proximate to the refuse container, present, via the user interface, an indicator of the operation including a request for an operator acknowledgement of the operation, receive the operator acknowledgement of the operation, and operate, responsive to receiving the operator acknowledgement, the actuator of the grabber assembly to complete the operation.

Another embodiment of the present disclosure relates to a grabber assembly for a refuse vehicle. The grabber assembly may include a plurality of actuators, a sensor to generate sensor data indicative of a position of a refuse container, a user interface, and a control system communicably coupled to the sensor and the user interface. The control system may determine, based on the sensor data, an operation of the grabber assembly corresponding to at least one of the refuse container or an obstacle proximate to the refuse container, present, via the user interface, an indicator of the operation including a request for an operator acknowledgement of the operation, receive the operator acknowledgement of the operation, and operate, responsive to receiving the operator acknowledgement, the actuator of the grabber assembly to complete the operation.

Still another embodiment of the present disclosure relates to a method for refuse collection by a refuse vehicle including a grabber assembly. The method may include determining, by a control system of the refuse vehicle and based on sensor data generated by a sensor coupled to at least one of the refuse vehicle or the grabber assembly, an operation of the grabber assembly corresponding to at least one of a refuse container or an obstacle proximate to the refuse container. The method may include presenting, by the control system and via a user interface of the refuse vehicle, an indicator of the operation comprising a request for an operator acknowledgement of the operation. The method may include receiving, by the control system, the operator acknowledgement of the operation. The method may include operating, by the control system and responsive to receiving the operator acknowledgement, an actuator of the grabber assembly to complete the operation.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for use with any of the refuse vehicles of FIGS. 1-3, according to an exemplary embodiment;

FIG. 5 is a block diagram of a control system for detecting and grasping refuse containers, according to an exemplary embodiment;

FIG. 6A is a top view of the side-loading refuse vehicle of FIG. 3 interacting with a refuse container, according to an exemplary embodiment;

FIG. 6B is a top view of the side-loading refuse vehicle of FIG. 3 in a first state of operation, according to an exemplary embodiment;

FIG. 6C is a top view of the side-loading refuse vehicle of FIG. 3 in a second state of operation, according to an exemplary embodiment;

FIG. 6D is a top view of the side-loading refuse vehicle of FIG. 3 in a third state of operation, according to an exemplary embodiment;

FIG. 7 is a flow diagram of a method for detecting and grasping a refuse container, according to an exemplary embodiment;

FIG. 8 is a flow diagram of a method for depositing refuse into a refuse vehicle using a combination of preset automatic and manual operations, according to an exemplary embodiment;

FIG. 9 is a top view of the side-loading refuse vehicle of FIG. 3 with different grabber assembly configurations, according to an exemplary embodiment;

FIG. 10 is a flow diagram of a method for preset grabber assembly operations with user authorization, according to an exemplary embodiment;

FIG. 11 is a side view of a front-loading refuse vehicle shown completing part of a lift sequence, according to an exemplary embodiment; and

FIG. 12 is a side view of a rear-loading refuse vehicle shown completing part of a packing sequency, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Refuse vehicles (e.g., garbage trucks, waste collection trucks, sanitation trucks, etc.) are vehicles configured to collect, process, and transport refuse. Various embodiments of refuse vehicles include grabber assemblies or other systems configured to grasp (e.g., hold, couple with) refuse containers and deposit the contents of the refuse containers into the vehicle. Some embodiments of grabber assemblies may be fully operated by an operator of the vehicle. For example, the actuators of the grabber assemblies may be manually driven or otherwise operated via a user interface (e.g., a joystick, etc.) to manually control all movement operations of the grabber and/or lift system, including aligning the grabber assembly with the refuse container, grasping the refuse container, and depositing the contents of the refuse container into the vehicle. Other embodiments of grabber assemblies may be operated fully automatically by a vehicle or grabber arm controller (e.g., without operator involvement).

Referring generally to the Figures, a refuse collection system for a refuse vehicle is provided that enables automatic adjustment/operation of various vehicle functions, such as to preset or sensed operating positions, responsive to individual operator inputs. The refuse collection system may utilize proximity sensors, timers, or macros stored in memory to facilitate movement and determination of desired operating positions and/or functions relative to different refuse can sizes, positions, and/or other container and/or vehicle conditions. Among other benefits, the combination of automatic and manual operations of the grabber assembly may result in improved refuse collection capability and/or ease of use for vehicle operators.

For example, in some embodiments, the refuse vehicle is configured to automatically detect the type and/or size of refuse containers alongside the refuse vehicle. The refuse vehicle may include a grabber assembly configured to automatically adjust a distance between grabber arms such that obstacles near (e.g., adjacent to) refuse containers can be avoided while maintaining a width capable of grasping the refuse container. The adjustment may be based on a width of the refuse container and/or a width of a gap (e.g., space, opening) between the refuse container and the obstacle. The refuse vehicle may also include a user interface element (e.g., a button) in the cab of the vehicle or at another location along the vehicle that is configured to control actuation of the grabber assembly between different preset stages of operation, where an operator progresses through different stages of operation by successively depressing the user interface element, for example.

In some embodiments, the refuse vehicle includes a user interface including one or more user-selectable elements. The selectable elements may be configured to perform preset operations of the grabber assembly. For example, interaction with a first selectable element may perform a first set of tasks relating to aligning the grabber assembly and the refuse container. As another example, interaction with a second selectable element may perform a second set of tasks relating to grasping the refuse container. As yet another example, interaction with a third selectable element may perform a third set of tasks relating to depositing the contents of a refuse container into a refuse vehicle.

In other embodiments, the selectable elements may each control operation of the grabber assembly (or another refuse vehicle function, such as the packer assembly, etc.) between preset operating modes for different refuse can sizes. For example, a first selectable element may correspond with a refuse can of a first size, and may be depressed multiple times to progress through preset collection operations for the refuse can of the first size. A second selectable element may be depressed to sequency through refuse collection operations for a refuse can of a second size that is greater than the first size, etc. In other embodiments, the selectable elements may be configured to perform other preset of tasks associated with the grabber assembly and/or other functions of the refuse vehicle.

In some embodiments, the selectable elements may be programmed or otherwise set to perform any other sequence of operations and/or tasks desired by the vehicle operator. For example, the operator may record a pattern or sequence of operations for a refuse vehicle function and map the recorded sequence to one or more user-selectable elements. Such an approach can reduce operator fatigue and can also improve collection efficiency.

### Refuse Vehicle

### Front-loading Configuration

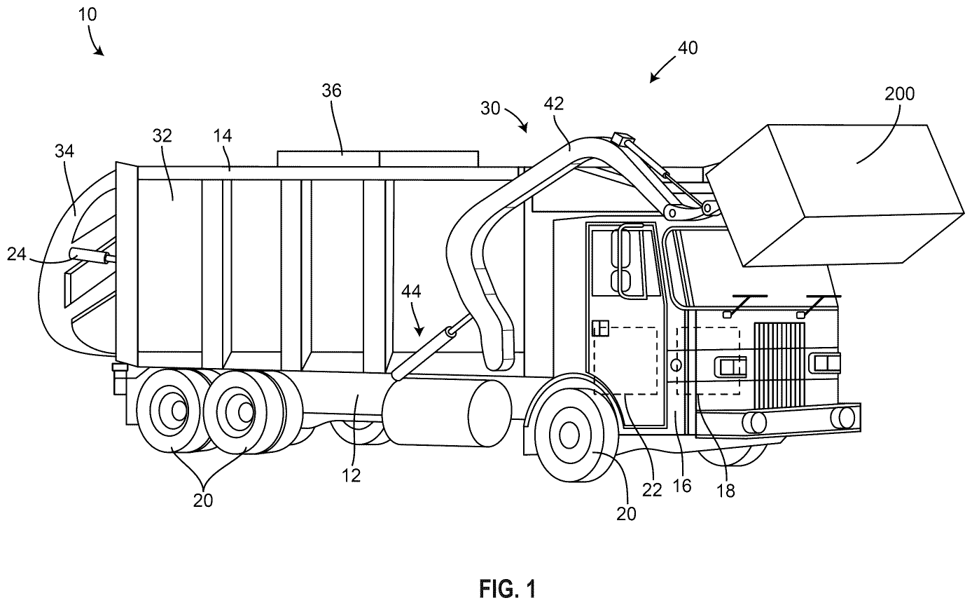

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as tractive elements 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 may be driven to pivot by lift arm actuators 44 to lift and empty the refuse container 200 into the hopper volume for compaction and storage. The lift arms 42 may be coupled with a pair of forks or elongated members that may removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

### Rear-loading Configuration

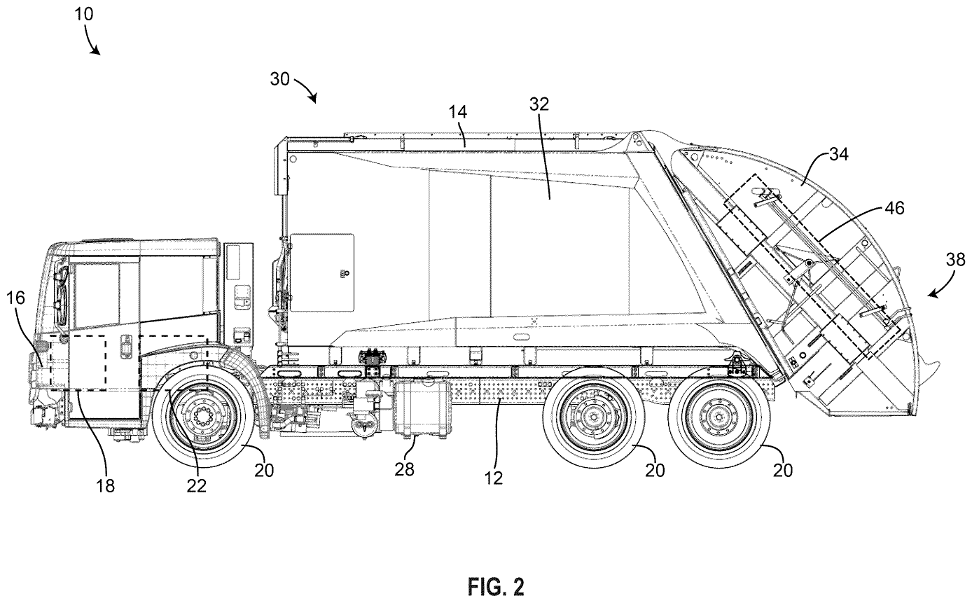

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-loading Configuration

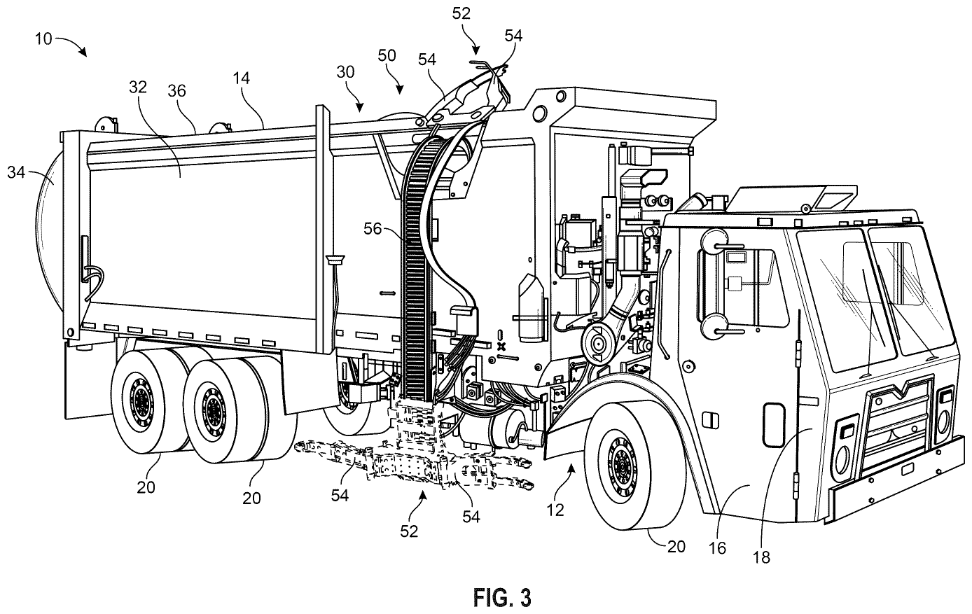

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

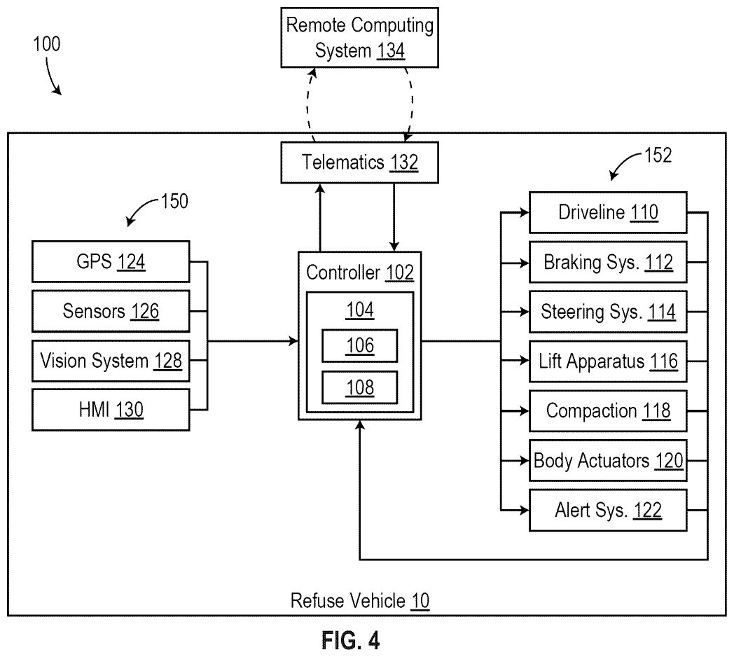

Referring to FIG. 4, the refuse vehicle 10 may include a control system 100 that is configured to facilitate operation of the refuse vehicle 10, or components thereof. In some embodiments, the control system 100 is configured to provide autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein. Although various aspects of fully autonomous operation may be implemented by the controller 102, it should be understood that the controller 102 may also be configured to facilitate semi-autonomous operation of the refuse vehicle in different preset operating modes, for example, based on operator inputs to the HMI 130.

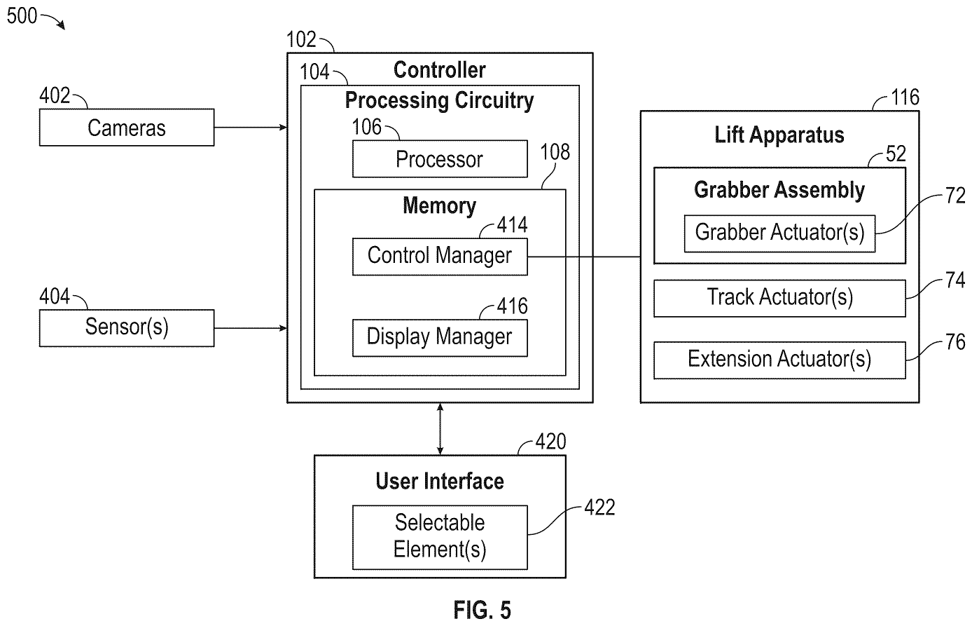

Referring to FIG. 5, a refuse collection system, shown as control system 500, for a refuse vehicle 10 is shown, according to an exemplary embodiment. In the embodiment of FIG. 5, the control system 500 is configured as a grabber arm control system to perform various operations of the grabber assembly responsive to individual user inputs. Control system 500 is shown to include a controller 102 to facilitate the detection and grasping of refuse containers based on various inputs and/or preset control algorithms in memory 108. The controller 102 is shown to include processing circuitry 104, including a processor 106 to execute instructions stored on memory 108. Memory 108 includes a control manager 414 that may control elements of the lift apparatus 116. Memory 108 also includes a display manager 416 that may facilitate the displaying of image and/or video to a user interface 420 and/or receive instructions from the user interface 420 (e.g., from user-selectable elements corresponding with different preset operations).

The controller 102 may receive sensor data from one or more sensors disposed on the vehicle 10. In the embodiment of FIG. 5, the controller 102 may receive image data from one or more cameras 402 disposed on the outside (e.g. body, outer surface, external surface) of the vehicle 10. The cameras 402 may capture image and/or video feed of an area surrounding the vehicle 10 (e.g., sidewalks, driveways, lawns, etc.). The controller 102 (e.g., via the processor 106) may analyze or otherwise process the image data to detect a refuse container in the area surrounding the vehicle 10. In some embodiments, the controller 102 may detect the refuse container based on any of a size, shape, color, dimensions, and/or other identifier of the refuse container. The controller 102 may determine or otherwise determine characteristics of the refuse container. By way of example, the controller 102 may determine a width and/or a height of the refuse container based on images from the cameras 402. By way of another example, the controller 102 may be configured to determine a first location corresponding to a first side of the refuse container, and a second location corresponding to a second side of the refuse container.

In some embodiments, the controller 102 may analyze or otherwise process the image data from the cameras 402 to determine whether there are obstacle(s) near (e.g., adjacent to) the refuse container. The controller 102 may determine or otherwise calculate a distance between the refuse container and the obstacle. For example, the controller 102 can determine that the obstacle is a first distance away from the refuse container. As another example, the controller 102 can determine that there is a gap (e.g., space, opening) of a certain size between the obstacle and the refuse container. The controller 102 may determine or otherwise calculate a gap (e.g., opening, space) between the refuse container and the obstacle. The controller 102 may detect or otherwise determine characteristics of the obstacle, such as a size (e.g., dimensions such as a height, etc.) or shape of the obstacle. The controller 102 may also determine other characteristics of the obstacle, including characteristics indicative of the type of obstacle (e.g., a color of the obstacle, or other features of the obstacle).

Referring to FIGS. 3 and 5, the controller 102 is shown to be communicatively coupled to sensor(s) 404 and configured to receive sensor data from the sensor(s) 404 regarding the spacing (e.g., distance) between grabber arms 54 of the grabber assembly 52, the distance between the grabber assembly and the body of the refuse vehicle, and/or the proximity of the grabber arms 54 to the refuse can. The sensors 404 may include one or more proximity sensors, such as ultrasonic sensors, laser sensors, infrared sensors, radar sensors. In some embodiments, the sensors 404 may include displacement sensors or a different type of sensor. For example, the sensors may include any of the sensors and functionalities to facilitate refuse container type and position detection as described with respect to U.S. patent application Ser. No. 18/630531, filed Apr. 9, 2024, the entire contents of which are hereby incorporated by reference herein.

In some embodiments, the controller 102 may analyze or otherwise process the sensor data (e.g., via the processor 106) to determine a spacing between the grabber arms 54. In some embodiments, the spacing between the grabber arms 54 is one measurement of length between a first grabber arm 54 and a second grabber arm 54. In other embodiments, the spacing between grabber arms 54 is based on a displacement of each grabber arm 54 from a center point of the grabber assembly 52. In other embodiments, the controller 102 may determine the spacing between grabber arms 54 based on an operation time of a grabber actuator 72 of the grabber assembly 52 (e.g., based on an operation time stored in memory, etc.). For example, if the grabber actuator 72 may adjust the position of the grabber arms 54 at a constant rate, the controller 102 may determine the spacing of the grabber arms 54 based on the constant rate and the time of operation of the grabber actuator 72.

The control manager 414 may control or otherwise transmit instructions to the lift apparatus 116 based on the determined grabber arm position, refuse can characteristics, and/or operator inputs. The lift apparatus may receive instructions from the control manager 414 and facilitate the grasping and moving of the refuse container, among other operations. The lift apparatus 116 is shown to include the grabber assembly 52. The grabber assembly 52 is shown to include one or more grabber actuators 72 configured to rotate the grabber arms 54 about an axis extending through a bushing. The grabber actuators 72 are configured to releasably secure the grabber arms 54 and a refuse container, according to an exemplary embodiment. The grabber actuators 72 may rotate the grabber arms 54 about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52.

The lift apparatus 116 is shown to include one or more track actuator(s) 74 configured to move the grabber assembly 52 relative to the vehicle 10 body. The track actuators 74 can move (e.g., translate, facilitate movement of) the grabber assembly 52 in a horizontal direction along a track deposited along a length of the vehicle 10 body. This may allow for alignment of the grabber assembly 52 with the refuse container. The track actuators 74 can move (e.g., translate, facilitate movement of) the grabber assembly 52 in a vertical direction along a track disposed along a height of the vehicle 10 body. This may allow for depositing of the contents of the refuse container into the vehicle. For example, in a side-loading refuse vehicle 10, the track actuators 74 may translate the grabber assembly 52 vertically, thereby allowing contents of a refuse container to be deposited into an opening on a top portion of the vehicle 10.

The lift apparatus 116 is shown to include one or more extension actuator(s) 76 configured to move the grabber assembly relative to the vehicle 10 body. The extension actuators 74 can move (e.g., translate, facilitate movement of) the grabber assembly towards and/or away from the vehicle 10 and/or to lift the grabber assembly relative to the vehicle 10 to discharge contents of the refuse can into the vehicle 10. In some embodiments, the extension actuator(s) 76 are configured to increase the grasping range of the grabber assembly 52, such that the vehicle 10 can be further from the refuse container and still be able to grasp the refuse container. The extension actuators 76 can include telescoping members, a scissors stack, or any other assembly that can extend or retract to provide additional reach of the grabber assembly 52 for refuse collection.

Referring to FIG. 5, the controller 102 is shown to be communicatively coupled to a user interface 420. The user interface 420 may display information associated with the detection and grasping of refuse containers. In some embodiments, the display manager 416 may determine and/or identify information that should be displayed to the user interface 420. For example, the display manager 416 can determine that image data from the camera(s) 402 should be displayed on the user interface 420. In some embodiments, the display manager 416 may display messages to the user interface 420 requesting user authorization (e.g., confirmation, assistance, feedback, etc.) regarding operations of the vehicle 10. For example, if the controller 102 is unable to determine whether an object is a refuse container, the display manager 416 may display image data to the user interface 420, and request that the user indicates whether the object is a refuse container.

The display manager 416 may present information to an operator regarding refuse collection operations. For example, the display manager 416 may display an indication of a suggested refuse collection operation based on information received from the control manager 414 (e.g., based on characteristics of the refuse can, characteristics of the obstacle, and/or a current position of one or more actuators). In some embodiments, the display manager 416 may display a list of different preset refuse collection operations for the operator to select, such as refuse collection operations that have been previously recorded by the operator via the user interface and stored in memory. The display manager 416 may solicit operator input before performing any refuse collection operations.

The user interface 420 is shown to include one or more selectable element(s) 422 configured to provide feedback from the user to the controller 102 regarding operations of the vehicle 10. The selectable elements 422 may include at least one of touch screens, buttons, switches, joysticks, remote controllers, dials, and/or other interfaces configured to facilitate communication between a user and the controller 102. For example, the selectable elements 422 can include at least one button and/or joystick on a steering wheel in the cab of the vehicle, which can simplify user interaction with the refuse collection system. In some embodiments, the selectable elements 422 can be used (e.g., interacted with) to provide acknowledgement to the controller 102 regarding refuse container detection. For example, the user may interact with a selectable element responsive to a notification to the user interface 420 requesting feedback regarding whether an object is a refuse container, to confirm the determined size of the refuse container, and/or other determined characteristics of the refuse container, obstacle(s), and/or grabber arm position. In some embodiments, the selectable elements 422 can be used (e.g., interacted with) to facilitate grasping of refuse containers (e.g., by the grabber assembly 52). For example, the user may interact with a selectable element to initiate movements of the lift apparatus 116 or another refuse vehicle function between operating states.

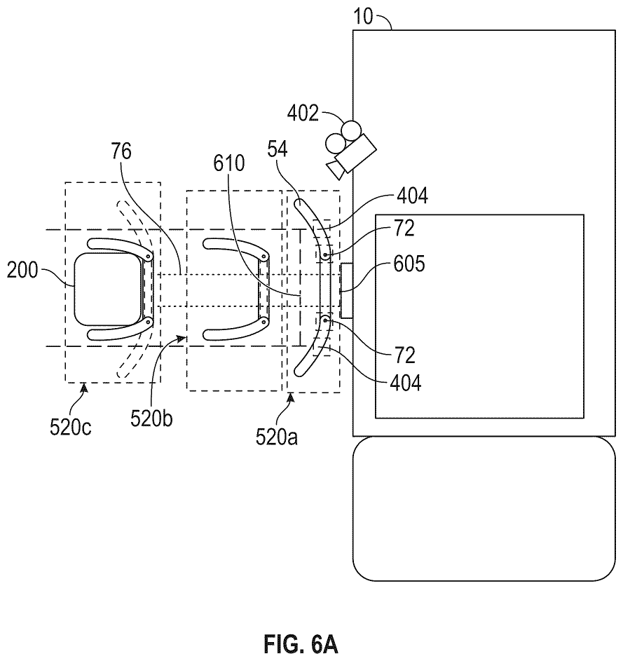

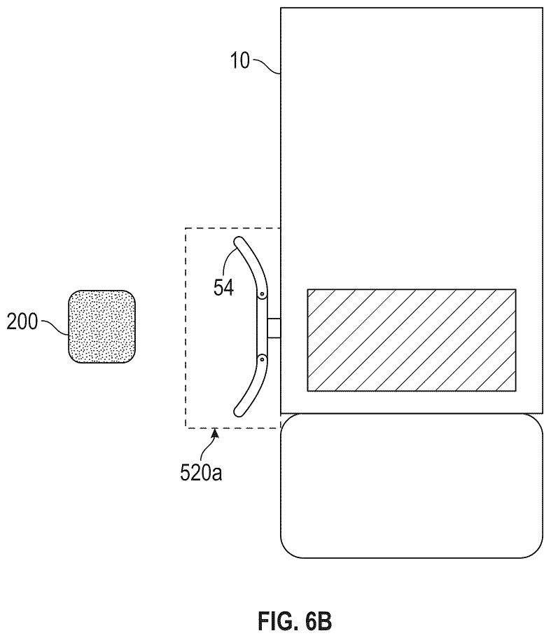

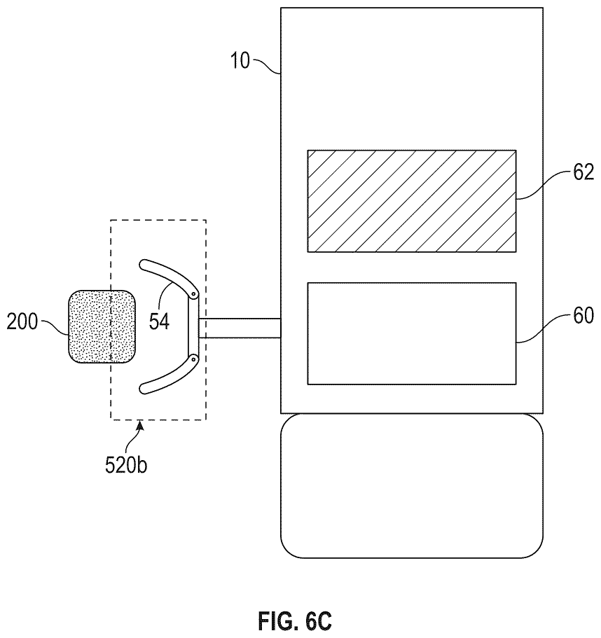

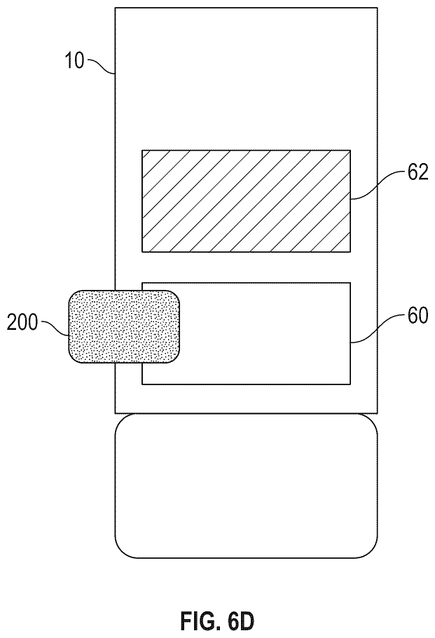

Referring to FIG. 6A, depicted is the grabber arms 54 of the vehicle 10 grasping a refuse container 200 under a multi-stage (e.g., multi-tiered, etc.) process, according to an exemplary embodiment. The camera 402 may facilitate detection of the refuse container 200. Based on image data captured by the camera, a controller (e.g., controller 102) of the vehicle 10 may determine information regarding the refuse container 200. For example, the controller 102 may determine a size (e.g., dimensions) of the refuse container 200. Based on the information of the refuse container 200, the controller may determine whether the grabber assembly 52 is properly aligned with the refuse container 200. In some embodiments, a determination of alignment of the grabber assembly 52 with the refuse container 200 may depend on whether a center point 605 of the grabber assembly 52 aligned with (e.g., in front of, lined up with) a front portion of the refuse container 200. If the grabber assembly 52 is not properly aligned with the refuse container 200, one or more actuators (e.g., track actuators 74, engine 18) may be operated to adjust the position of the grabber assembly 52 or the vehicle 10 relative to the refuse container 200. The grabber assembly 52 alignment may be facilitated automatically by the controller, or performed manually by the vehicle operator.

Once the grabber assembly 52 has been properly aligned with the refuse container 200, the controller may determine a width of the refuse container 200 based on the image data from the camera 402. In some embodiments, the controller may determine a distance 610 between the grabber arms 54 based on sensor data from the sensors 404. In some embodiments, the default (e.g., base, starting) positioning of the grabber assembly is to be in a fully open state 520a. In the fully open state 520a, the grabber actuator(s) 72 are rotated (e.g., pivoted, extended, etc.) such that the distance 610 between the grabber arms 54 can no longer be increased. Based on the distance 610 between the grabber arms 54, the width of the refuse container 200, and/or other features of the environment around the refuse vehicle 10 (e.g., obstacles), the controller may determine that the distance 610 should be decreased before the grabber assembly 52 is extended to the refuse container 200.

In some embodiments, the controller may determine, based on the image data from the cameras 402, that there is an obstacle adjacent to the refuse container 200. Depending on the location of the obstacle, the grabber arms 54 may be unable to reach the refuse container in the fully open state 520a. The controller may operate the grabber actuator(s) 72 responsive to a single input from the user interface (e.g., responsive to an operator depressing a selectable element) to decrease the distance 610 between grabber arms 54 to a first distance based on the location of the obstacle and the width of the refuse container. By decreasing the distance 610 between grabber arms, the refuse container 200 can be accessed by the grabber assembly 52 without interfering with (e.g., touching, contacting) the obstacle.

The controller may decrease the distance 610 between grabber arms 54 based on the location of the obstacle and/or the width of the refuse container 200. In some embodiments, the controller may determine a partially grasped state 520b that allows the distance 610 between the grabber arms to be smaller than the distance 620 between the grabber arms 54 in the fully open state 520a, while allowing the distance 610 to remain at least as wide as the refuse container 200. The controller may control actuation of the grabber arms 54 to move the grabber arms 54 to the partially grasped state 520b responsive to an individual user input (e.g., responsive to a first single button press of the user-interface element, etc.). After adjusting the grabber arms 54 to be in the partially grasped state 520b, the controller can cause the extension actuator(s) 76 to move the grabber assembly 52 towards the refuse container 200 (e.g., responsive to a second single button press of the user-interface element, etc.). The extension actuator(s) 76 can move the grabber assembly 52 until the center point 605 of the grabber assembly 52 contacts (e.g., touches, senses, is within a threshold distance of, etc.) the refuse container 200. For example, the extension actuator(s) 76 may extend the grabber assembly 52 until sensor data from proximity sensors indicate that the refuse container 200 is within a threshold distance of the grabber arms 54. As another example, the extension actuator(s) may extend the grabber assembly 52 for an amount of time based on preset timers stored in memory.

The controller may control or otherwise operate the grabber actuators 72 to position the grabber arms 54 in a fully grasped state 520c (e.g., responsive to a third single button press of the user-interface element, etc.). In the fully grasped state 520c, the distance 610 between the grabber arms 54 are decreased such that the grabber arms 54 can grasp the refuse container 200 with enough force (e.g., pressure) to keep the refuse container 200 in the grabber arms 54 while moving. In some embodiments, the distance 610 between the grabber arms 54 in the fully grasped state 520c is based on the width of the refuse container 200. In some embodiments, the distance 610 between the grabber arms 54 in the fully grasped state 520c is based on a sensor reading, such as a contact sensor, force sensor, resistance sensor, or other sensor capable of monitoring a coupling between the grabber arms 54 and the refuse container 200.

The controller may perform an automatic refuse dumping routine to lift the refuse container 200 and discharge its contents into the refuse vehicle 10 responsive to another single button press of the user-interface element. It should be appreciated that the number and/or type of preset operating sequences may be different in various embodiments and depending on user preferences (e.g., two or more of the above operations may be combined, individual operations may be separated, etc.).

Referring to FIGS. 5 and 6A, in some embodiments, the controller 102 may detect the refuse container 200 automatically (e.g., without operator involvement). For example, the cameras 402 can capture the image data, and the controller 102 can determine whether a refuse container 200 is present based on the image data. In some embodiments, the operator of the vehicle 10 can manually determine whether a refuse container 200 is present. For example, the operator can view the image data from the cameras 402 and determine whether a refuse container 200 is present. As another example, the vehicle operator can view a refuse container 200 while operating the vehicle 10. In some embodiments, the controller 102 may detect the refuse container 200 using a combination of automatic and manual operations. For example, the controller 102 may display a message requesting operator authorization (e.g., feedback, assurance) regarding the detection of the refuse container 200 before further action is taken. The operator can interact with one or more selectable elements 422 of the user interface 420 to acknowledge that (a) the controller 102 properly identified a refuse container 200 or (b) the controller 102 did not properly identify a refuse container 200.

In some embodiments, the controller 102 may cause the grabber arms 54 to grasp the refuse container 200 automatically (e.g., without operator involvement). For example, the cameras 402 can capture image data such that the controller 102 can determine whether an obstacle is adjacent to the refuse container 200. The controller 102 can adjust the distance between grabber arms 54 such that the grabber assembly 52 avoids the obstacle, and the controller 102 can operate the extension actuators 76 to move the grabber assembly 52 towards the refuse container. The controller can then adjust the grabber arms 54 to grasp the refuse container 200 without an operator input (e.g., involvement, instruction). In some embodiments, the vehicle operator can manually operate the actuators (e.g., grabber actuators 72, extension actuators 76) to grasp the refuse container 200. For example, the operator can view (e.g., visually identify) obstacles, adjust the grabber arms 54 to avoid the obstacle, operate the extension actuators 76, and adjust the grabber arms 54 to grasp the refuse container.

In some embodiments, the controller 102 may grasp the refuse container using a combination of automatic and manual operations. For example, the controller 102 can analyze or otherwise process the image data from the cameras 402 to determine a location of an obstacle. The controller 102 can display the obstacle to the user interface 420, and request user authorization before adjusting the grabber arms 54 to be in a position that avoids the obstacle. Responsive to receiving authorization (e.g., via operator interaction with selectable elements 422), the controller 102 can automatically adjust the grabber arms 54 by operating the grabber actuators 72. The controller 102 can request user authorization before completing other processes associated with grasping the refuse container 200 (e.g., extending grabber assembly 52 towards refuse container 200, grasping refuse container).

In some embodiments, the controller 102 may deposit the contents of the refuse container 200 into the vehicle 10 automatically. For example, the controller 102 can automatically operate the extension actuators 76 to move (e.g., translate, bring) the grabber assembly 52 towards the vehicle 10, operate the track actuators 74 to move the grabber assembly 52 towards a top portion of the vehicle 10, and tilt the grabber assembly 52 to deposit the contents of the refuse container 200 into the vehicle 10. In other embodiments, the operator can manually operate actuators (e.g., extension actuator 76, track actuator 74) of the vehicle 10 to move the refuse container 200 towards the vehicle 10 and deposit the contents of the refuse container 200 into the vehicle 10.

In some embodiments, the controller 102 may deposit the contents of the refuse container 200 into the vehicle 10 using a combination of automatic and manual operations. For example, the controller 102 can request operator authorization before moving the grabber assembly 52 towards the vehicle. As another example, the controller 102 can request operator authorization before depositing the contents of the refuse container into the vehicle 10. The operator can interact with the selectable elements 422 of the user interface 420 to acknowledge and/or suspend (e.g., terminate, delay, disable) operations of the vehicle before the controller 102 performs the operations.

Referring to FIG. 6B, depicted is the vehicle 10 in a first state of operation, according to an exemplary embodiment. In the first state of operation, the vehicle 10 may be positioned (e.g., automatically, by the operator) to grasp the refuse container 200. The vehicle 10 may be positioned near (e.g., adjacent to) the refuse container 200 such that a track extending along a side surface of the vehicle 10 is in range of (e.g., adjacent to) the refuse container 200. If the grabber arms 54 are not aligned with the refuse container 200, the grabber arms 54 may translate along the track extending along the side surface of the vehicle 10 such that a center point of the grabber arms 54 is adjacent to the refuse container 200. In some embodiments, alignment of the grabber arms may be performed automatically by a controller of the vehicle 10. In some embodiments, alignment of the grabber arms may be facilitated by the operator of the vehicle (e.g., responsive to a first button press). In the first state of operation, the grabber arms 54 may be in the fully open state 520a to allow or otherwise facilitate proper alignment of the grabber arms 54 with the refuse container.

Referring to FIG. 6C, depicted is the vehicle 10 in a second state of operation, according to an exemplary embodiment. In the second state of operation, the grabber arms 54 may extend outward toward the refuse container 200 (e.g., away from the vehicle 10). In some embodiments, the grabber arms 54 may automatically extend to a distance determined by a controller of the vehicle 10 (e.g., based on proximity sensor data and/or image data). In some embodiments, extension of the grabber arms 54 may be facilitated by the operator of the vehicle (e.g., a second button press, a sustained button press). For example, the operator of the vehicle may sustain the press of a button for an amount of time corresponding to the grabber arms 54 extending a desired distance. In some embodiments, the grabber arms 54 may be in the fully open state 520a (e.g., if no obstacle is detected). In some embodiments, the grabber arms 54 may be in the partially grasped state 520b if an obstacle is detected adjacent to the vehicle 10 or the refuse container 200. In the partially grasped state 520b, the grabber arms 54 may be positioned (e.g., partially closed) such that a distance between the grabber arms 54 allows the grabber arms 54 to avoid interfering with the obstacle while the grabber arms 54 are being extended toward the refuse container 200, while allowing for grasping of the refuse container 200 by the grabber arms 54.

In some embodiments, while in the second state of operation, the vehicle may perform other operations. For example, if a hopper opening 60 of the vehicle 10 is covered by a hopper door 62, the second state of operation may trigger (e.g., cause, facilitate) operation of actuators to remove (e.g., slide, translate, move) the hopper door 62 from the hopper opening 60. Removal of the hopper door 62 may allow for subsequent depositing of refuse from the refuse container 200 into the hopper opening 60.

Referring to FIG. 6D, depicted is the vehicle 10 in a third state of operation, according to an exemplary embodiment. With reference to FIGS. 6A and 6D, in the third state of operation, the grabber arms 54 may fully grasp the refuse container 200. In some embodiments, the grabber arms 54 may automatically grasp the refuse container 200 (e.g., move closer together until a proximity sensor senses that the refuse container 200 is grasped). In some embodiments, grasping of the refuse container 200 by the grabber arms 54 is facilitated by the operator of the vehicle. For example, the operator may press a button causing the grabber arms 54 to grasp the refuse container 200. As another example, the operator may press a button for a sustained period of time corresponding to closing of the grabber arms 54. The third state of operation may include retracting the grabber arms 54 towards the vehicle, lifting the refuse vehicle 10 towards a hopper opening on a top portion of the vehicle 10, and/or depositing the contents of the refuse container 200 into the hopper opening 60.

Referring to FIGS. 6B-6D, after depositing the contents of the refuse container 200 into the hopper opening, the vehicle 10 may undergo (e.g., perform) a reversal state of the first, second, and/or third state(s) of operation. In some embodiments, the reversal state is done automatically by a controller of the vehicle 10. In other embodiments, the reversal state is performed (e.g., facilitated) by an operator of the vehicle. The reversal state may include any steps (e.g., features) that lowers the refuse container 200 and places the refuse container in its initial position. After the reversal state is completed the grabber arms 54 may be in the fully open state 520a to prepare for grasping other refuse containers.

In some embodiments, the reversal state may include stowing or otherwise storing the grabber arms 54 in the vehicle 10 for transit operations. In some embodiments, the controller of the vehicle may stow the grabber arms 54 in the hopper opening 60. In some embodiments, the grabber arms 54 may be positioned in a downward position (e.g., parallel to a side surface of the vehicle) such that they do not extend from the vehicle while in transit. In some embodiments, the grabber arms 54 may be raised or otherwise lifted such that they do not interfere with obstacles on the road in transit.

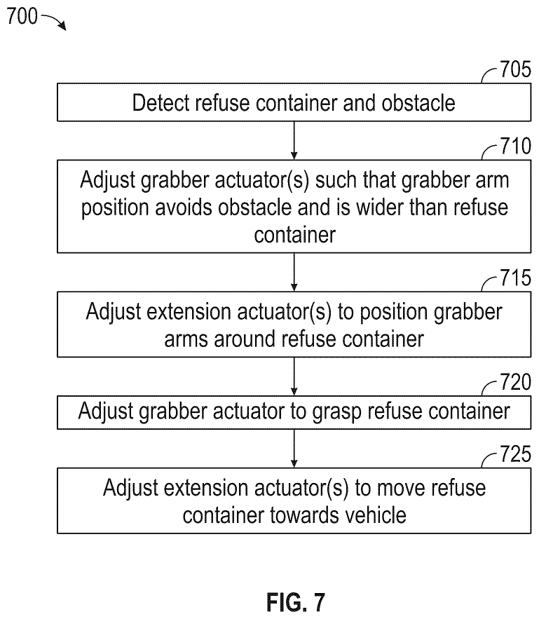

Referring to FIG. 7, depicted is a flow diagram of a method 700 for detecting and grasping refuse containers, according to an exemplary embodiment. At step 705, one or more processors (e.g., of the vehicle 10, of the controller 102) may detect a refuse container 200 and an obstacle. The refuse container 200 and the obstacle may be detected based on image data captured by one or more cameras (e.g., cameras 402) disposed on an outer surface of the vehicle 10. The one or more processors may detect information regarding the refuse container 200 and the obstacle, such as a size (e.g., dimensions), positioning, distance between, and other measurable features of the obstacle and/or the refuse container 200.

At step 710, the one or more processors may operate the grabber actuators 72 such that the distance between the grabber arms 54 is narrow enough to avoid the obstacle upon extension of the extension actuators 76, while remaining wider than the refuse container 200. In some embodiments, the positioning of the grabber arms may be the same as the partially grasped state 520b. In some embodiments, the grabber actuators 72 may move both grabber arms 54 simultaneously, such that the distance between each of the grabber arms 54 and the center of the grabber assembly 52 is the same. In other embodiments, the grabber actuators 72 may move one of the grabber arms 54 such that the grabber assembly 52 avoids the obstacle without moving both grabber arms 54.

At step 715, the one or more processors may operate or otherwise control the extension actuator(s) 76 such that the grabber arms 54 are positioned around (e.g., adjacent to) the edges (e.g., sides) of the refuse container 200. The extension actuator(s) 76 may move the grabber assembly 52 towards the refuse container 200 without adjusting the alignment of the grabber arms 54 and the refuse container 200. The extension actuator(s) 76 may extend outward until the grabber assembly 52 contacts the refuse container 200 and/or until a sensor of the grabber assembly 52 senses (e.g., detects, measures, determines) that the grabber assembly 52 is in position to couple with the refuse container 200.

At step 720, the one or more processors may adjust or otherwise operate the grabber actuator 72 to grasp the refuse container 200. In some embodiments, the positioning of the grabber arms 54 may be the same as the fully grasped state 520c. In the fully grasped state 520c, the grabber arms 54 may be in contact with the sides of the refuse container 200 such that the refuse container 200 is not released from the grabber arms 54 when the grabber assembly is moved (e.g., by the extension actuator(s) 76, by the track actuator(s) 74).

At step 725, the one or more processors adjust or otherwise operate the extension actuator(s) 76 to move the refuse container towards the vehicle 10. In some embodiments, the track actuators 74 work simultaneously with and/or before the extension actuators 76 to lift the refuse container 200 above the ground before moving. Once the extension actuators 76 are fully retracted (e.g., returned) to the vehicle 10, the track actuators 74 may lift the refuse container 200 towards the top portion of the vehicle 10, and tilt the refuse container 200 such that the contents of the refuse container 200 are deposited into an opening located on the top portion of the vehicle 10.

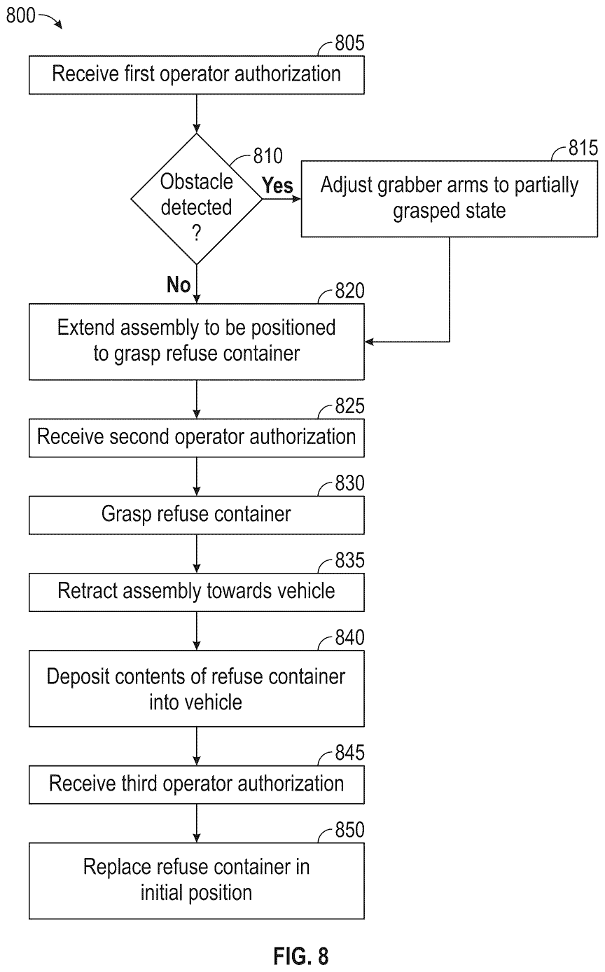

Referring to FIG. 8, depicted is a method 800 for depositing of refuse into the refuse vehicle 10 using a combination of automatic and operator-initiated operations, according to an exemplary embodiment. To simplify operations for an operator of the vehicle 10, it may be beneficial to delegate tasks to be performed automatically by the vehicle 10 into separate commands that the operator can initiate or otherwise authorize by interacting with a user interface displayed within or remote from the vehicle 10. For example, the operator can periodically interact with selectable elements of the user interface to affirm that automatic actions taken by the vehicle 10 have been executed properly. At step 805, one or more processors (e.g., of the controller 102) may receive a first operator authorization from the user interface 420. The first operator authorization may indicate to the controller 102 that the contents a refuse container automatically detected by the vehicle 10 should be deposited into the vehicle 10. A first operator authorization may be transmitted to the controller 102 responsive to an operator interacting with a selectable element 422 (e.g., button, switch, touch screen, dial, joystick, etc.) of the user interface 420.

At step 810, the one or more processors determine whether an obstacle is near (e.g., adjacent to) a refuse container. The controller 102 may determine or otherwise detect characteristics of obstacles such as a size, dimensions, positions, and/or a location relative to the refuse container. Responsive to detecting an obstacle, the controller 102 may determine whether the grabber arms 54 should be partially grasped (e.g., brought together, closed) to avoid contacting the obstacle. At step 815, if an obstacle is detected, the one or more processors may adjust the grabber arms 54 to be in a partially grasped state. The partially grasped state may correspond to a grabber arm position that can avoid the obstacle while maintaining a distance between grabber arms that can (e.g., is wide enough to) facilitate grasping of the refuse container.

At step 820, the one or more processors may extend the grabber assembly 52 to be positioned to grasp the refuse container. The grabber arms 54 may be in a fully open state if no obstacle was previously detected or may be in the partially grasped state if an obstacle was previously detected. The grabber assembly 52 may be extended until the grabber assembly 52 contacts the refuse container 200, or until the controller 102 otherwise determines that the grabber assembly 52 is in position to grasp the refuse container. At step 825, the one or more processors may receive a second operator authorization from the user interface 420. The operator authorization may indicate that the previous steps (e.g., steps 805-820) were executed properly and/or that the grabber is in a proper position to grasp the refuse container. The operator authorization may be transmitted responsive to interaction with a selectable element 422 of the user interface 420. The selectable element 422 of step 825 may be the same selectable element 422 as step 805 or may be a different selectable element 422.

At step 830, the one or more processors may grasp the refuse container. The controller 102 may adjust the grabber arms 54 to a fully closed position such that the grabber arms 54 are contacting entire edges (e.g., sides) of the refuse container. At step 835, the one or more processors may retract or otherwise move the grabber assembly towards the vehicle. The controller 102 may lift the refuse container a predetermined distance above the ground before moving, such that the refuse container does not drag on the ground while moving. At step 840, the one or more processors may deposit the contents of the refuse container into the vehicle. In some embodiments, the controller operates one or more actuators to lift the refuse container to a top portion of the vehicle 10 and tilt the refuse container to deposit the contents of the refuse container into an opening of the vehicle. In some embodiments, the controller operates one or more actuators to remove (e.g., uncover, slide, translate) a lid covering an opening of the refuse container before depositing the contents of the refuse container into the vehicle 10.

At step 845, the one or more processors may receive a third operator authorization from the user interface 420. The third operator authorization may indicate that the previous steps (e.g., steps 830-840) were executed properly and/or that the contents of the refuse container were successfully deposited into the vehicle 10. The operator authorization may be transmitted responsive to interaction with a selectable element 422 of the user interface 420. The selectable element 422 of step 845 may be the same selectable element 422 as step 805 and/or step 825 or may be a different selectable element 422. At step 850, one or more processors configured to place the refuse container in its initial position (e.g., position before grasping).

Still referring to FIG. 8, the first operator authorization, second operator authorization, third operator authorization, and method 800 should be treated as exemplary, and in no way limiting. In other embodiments, there can be any number of operator authorizations that can be incorporated into any part of method 800. In other embodiments, there may be additional steps to be completed automatically by the controller 102 that are not included in method 800.

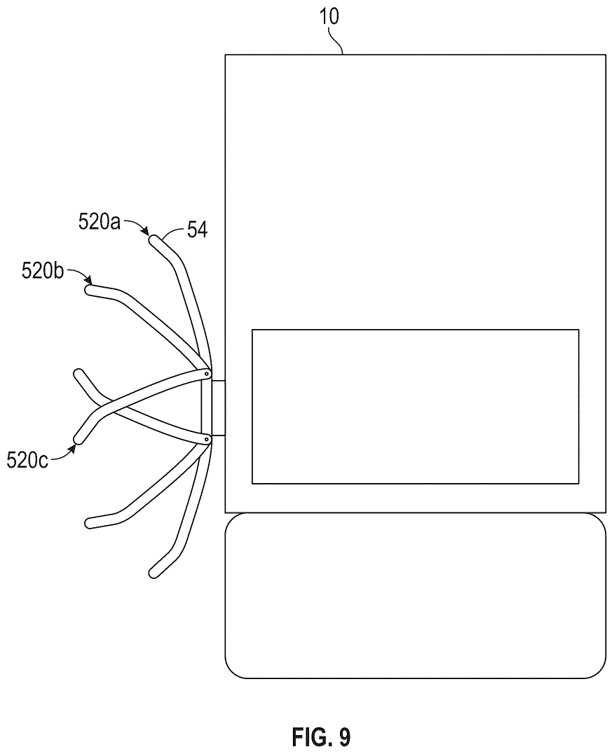

Referring to FIG. 9, depicted is the vehicle 10 with various grabber arm 54 configurations, according to an exemplary embodiment. The grabber arms are shown to be in a fully open state 520a. In the fully open state 520a, the grabber arms 54 are positioned at a maximum distance from each other, such that the distance between the grabber arms may not be increased. The grabber arms are shown to be in a fully grasped state 520c. In the fully grasped state 520c, the grabber arms are positioned one of (a) a minimum distance from each other, such that the distance between the grabber arms may not be decreased or (b) in contact with a refuse container, such that the distance between the grabber arms may not be decreased without damaging the refuse container and/or the grabber arms 54. The grabber arms 54 are shown to be in the partially grasped state 520b. In the partially grasped state 520b, the distance between the grabber arms 54 are at a distance between the fully open state 520a and the fully grasped state 520c. In some embodiments, the distance between the grabber arms 54 in the partially grasped state 520b may be based on a width and/or other dimensions of the refuse container. In other embodiments, the distance between the grabber arms 54 in the partially grasped state 520b may be based on a detected obstacle near (e.g., adjacent to) the refuse container.

Referring to FIGS. 5 and 9, the grabber arms 54 can transition between the fully open state 520a, partially grasped state 520b, and/or the fully grasped state 520c based on operator interactions with selectable elements 422 of the user interface. For example, grabber arms 54 may be in the fully open state 520a responsive to an operator pushing a button on the user interface 420. As another example, grabber arms 54 may be in the partially grasped state 520b responsive to an operator pushing a button on the user interface 420. As yet another example, grabber arms 54 may be in the fully grasped state 520c responsive to an operator pushing a button on the user interface 420.

In some embodiments, the selectable element 422 (e.g., button) is the same selectable element 422 for each state (e.g., fully open state 520a, partially grasped state 520b, fully grasped state 520c). For example, a first interaction with the selectable element 422 configures the grabber arms 54 in the fully open state 520a, a second interaction with the selectable element 422 configures the grabber arms 54 in the partially grasped state 520b, and a third interaction with the selectable element 422 configures the grabber arms 54 in the fully grasped state 520c. Additionally, or alternatively, the state may be based on a duration of an interaction with the selectable element. For example, an interaction with the selectable element 422 for a first duration configures the grabber arms 54 in the fully open state 520a, an interaction with the selectable element 422 for a second duration configures the grabber arms 54 in the partially grasped state 520b, and an interaction with the selectable element 422 for a third duration configures the grabber arms 54 in the fully grasped state 520c. In some embodiments, the selectable element 422 is a different selectable element for each state.

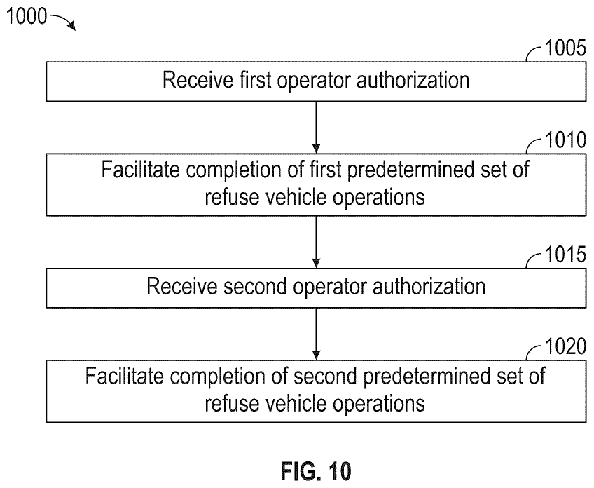

Referring to FIG. 10, depicted is a flow diagram of a method 1000 for completing preset refuse vehicle 10 operations responsive to operator authorization, according to an exemplary embodiment. At step 1005, the controller 102 receives a first operator authorization from a user interface. The first operator authorization may be transmitted responsive to an operator of the vehicle 10 interacting with a selectable element (e.g., button, switch, joystick, etc.) of the user interface. At step 1010, controller 102 may facilitate completion of a first predetermined set of refuse vehicle operations. The first set of refuse vehicle operations may involve operating actuators, capturing data, processing data, and/or any operations involving depositing refuse into the vehicle 10. At step 1015, controller 102 may receive a second operator authorization form the user interface. The second operator authorization may be transmitted to an operator of the vehicle 10 interacting with the selectable element. The selectable element may be the same selectable element as step 1005, or a different selectable element. At step 1020, the controller 102 may facilitate completion of a second predetermined set of refuse vehicle operations. The second set of refuse vehicle operations may involve operating actuators, capturing data, processing data, and/or any operations involving depositing refuse into the vehicle 10.

Referring to FIGS. 1, 5, and 10, the method 1000 may be applied to (e.g., conducted on) the front-loading refuse vehicle 10, according to an exemplary embodiment. At step 1005 a first operator interaction with a selectable element 422 may provide operator authorization to the vehicle 10. At step 1010, the operator authorization may cause the vehicle to perform operations relating to aligning and inserting the lift arms 42 (e.g., lift forks) into pockets of the refuse container. At step 1015, a second operator interactions with the selectable element 422 may provide a second operator authorization indicating that the lift arms 42 were properly inserted into the pockets of the refuse container. At step 1020, the second operator authorization may cause the lift arms 42 to raise and the contents of the refuse container to be deposited into the vehicle 10.

Referring to FIGS. 1 and 5, different selectable elements 422 of the user interface 420 may correspond to different operations of the front-loading refuse vehicle 10. For example, a first selectable element may raise the lift arms 42 and tilt the forking elements of the lift arms 42 in a downward direction, maintaining an angle between the lift arms 42 and the ground. As another example, a second selectable element may lower the lift arms and tilt the forking elements of the lift arms 42 in an upward direction, maintaining the angle between the lift arms and the ground. As another example, a third selectable element may position the lift arms 42 into a predetermined position corresponding to an average pocket height of refuse containers. As another example, a fourth selectable element may raise the lift arms 42 to deposit the contents of the refuse container into the vehicle 10, and subsequently place the refuse vehicle on the ground. As another example, a fifth selectable element may position the lift arms 42 and lift forks to accept an attachment, such as a carry can.

Referring to FIGS. 2 and 5, different selectable elements 422 of the user interface 420 may correspond to different operations of the rear-loading refuse vehicle. For example, a first selectable element may move a slide component and/or sweep component of the tailgate 34 to a position desirable for transit (e.g., movement, driving, transport). As another example, a set of selectable elements may perform operations relating to a pack cycle of the vehicle. As another example, a selectable element may tilt a refuse container towards the tailgate (e.g., for refuse depositing). As another example, a selectable element may place a refuse container on the ground.

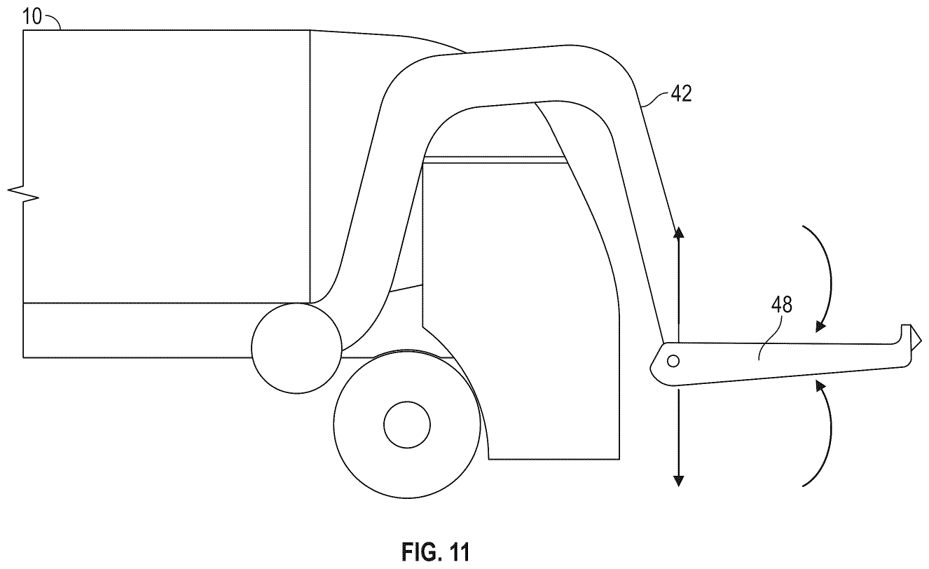

Referring to FIG. 11, depicted is a front-loading refuse vehicle 10, according to an exemplary embodiment. The vehicle 10 is shown to include the lift arms 42. The lift arms 42 are rotatably coupled to the body of the vehicle 10. The lift arms 42 are shown to include one or more forking elements 48 (e.g., lift forks) configured to pivot (e.g., tilt, angle) relative to the lift arms 42. The forking elements 48 may pivot such that when the lift arms 42 rotate relative to the body, the angle of the forking elements 48 relative to the ground remain constant.

Referring to FIGS. 10 and 11, the method 1000 may be applied to (e.g., conducted on) the front-loading refuse vehicle 10, according to an exemplary embodiment. At step 1005, a first operator interaction with a selectable element (e.g., a button press) may authorize movement of the lift arms 42 and/or the forking elements 48. At step 1010, based on the selectable element 422, the lift arms 42 and/or the forking elements 48 may be adjusted or otherwise moved. For example, based on the selectable element, the lift arms 42 may raise and the forking elements may tilt downward, such that the angle between the forking elements 48 and the ground is maintained. As another example, based on the selectable element, the lift arms 42 may lower and the forking elements 48 may tilt upward such that the angle between the forking elements 48 and the ground is maintained. As another example, based on the selectable element, the lift arms 42 and the forking element 48 may be positioned in a preset configuration. At step 1015, a second operation interaction with a selectable element (e.g., a button press) may authorize further movement of the lift arms 42 and/or forking elements 48. At step 1020, based on the selectable element, the lift arms 42 and/or the forking elements may be moved. For example, based on the selectable element, the lift arms 42 and the forking elements 48 may be operated or otherwise moved to automatically dump refuse into the vehicle 10 and place a refuse container back on the ground.

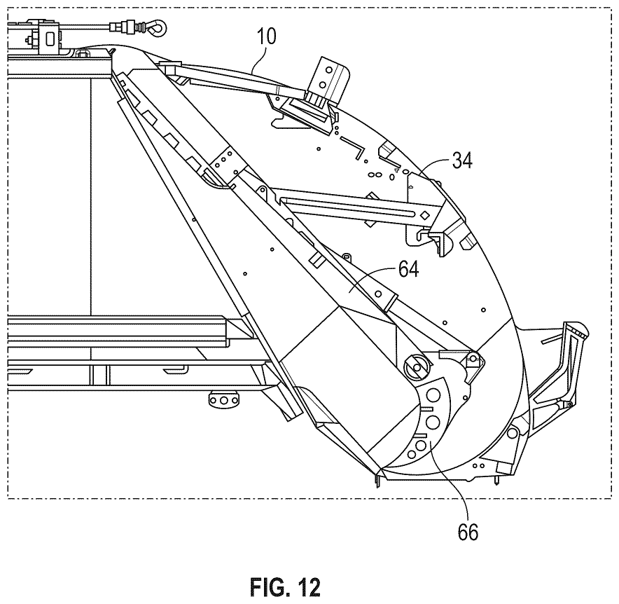

Referring to FIG. 12, depicted is the tailgate 34 of the rear-loading refuse vehicle 10, according to an exemplary embodiment. The tailgate 34 is shown to include a sliding mechanism 64 and a sweeping mechanism 66. The sliding mechanism 64 may move the sweeping mechanism 66 along a height (e.g., up and down) of the tailgate 34. The sweeping mechanism 66 is rotatably coupled to the sliding mechanism 64 and configured to pivot (e.g., rotate) relative to the sliding mechanism 64. In some embodiments, a user interface of the vehicle includes preset selectable elements configured to perform operations relating to the tailgate 34. For example, a first selectable element can cause the sliding mechanism 64 and the sweeping mechanism 66 to move together into a position suited for transit (e.g., move sliding mechanism 64 down, curl sweeping mechanism 66 in).

Referring to FIGS. 10 and 12, the method 1000 can be applied to the rear-loading refuse vehicle 10. According to an exemplary embodiment, an operator can interact with selectable element(s) to move through a pack cycle for the vehicle (e.g., steps 1005, 1015). Based on the selectable elements, actuators (e.g., sliding mechanism 64, sweeping mechanism 66, tailgate actuator) can be operated to perform pack cycle operations (e.g., steps 1010, 1020). For example, based on the selectable element, the sliding mechanism 64 may be raised/lowered and/or the sweeping mechanism may be curled in/out to load refuse into the vehicle. As another example, a selectable element can cause the tailgate 34 to tilt (e.g., via a tilting actuator) such that the contents of the refuse vehicle fall out of (e.g., are removed from) the vehicle. In some embodiments, the tilting actuator may be stowable. Stowing (e.g., storing) of the tilting actuator may be facilitated by selectable elements.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising;
a body;
a grabber assembly coupled to the body and comprising an actuator;
a sensor coupled to at least one of the body or the grabber assembly, the sensor configured to generate sensor data indicative of a position of a refuse container;
a user interface; and
a control system communicably coupled to the sensor and the user interface, the control system configured to:
determine, based on the sensor data, an operation of the grabber assembly corresponding to at least one of the refuse container or an obstacle proximate to the refuse container;
present, via the user interface, an indicator of the operation comprising a request for an operator acknowledgement of the operation;
receive the operator acknowledgement of the operation; and
operate, responsive to receiving the operator acknowledgement, the actuator of the grabber assembly to complete the operation.

2. The refuse vehicle of claim 1, wherein operation of the actuator causes an adjustment of a distance between a first grabber arm and a second grabber arm of the grabber assembly.

3. The refuse vehicle of claim 2, wherein the distance between the first grabber arm and the second grabber arm is a distance between a fully open state and a fully grasped state of the grabber assembly.

4. The refuse vehicle of claim 2, wherein the distance between the first grabber arm and the second grabber arm is based on at least one of (a) a width of the refuse container or (b) a distance between the refuse container and the obstacle.

5. The refuse vehicle of claim 1, wherein the operation is a first operation, wherein the actuator is a first actuator, and wherein the control system is configured to operate, responsive to a second operator acknowledgement, a second actuator of the grabber assembly to complete a second operation.

6. The refuse vehicle of claim 5, wherein the first operation is to operate the first actuator to extend the grabber assembly to the refuse container, and wherein the second operation is to operate the second actuator to operate the grabber assembly to grasp the refuse container.

7. The refuse vehicle of claim 5, wherein the operator acknowledgement is caused by a first interaction with a first selectable element of the user interface, and wherein the second operator acknowledgement is caused by a second interaction with a second selectable element of the user interface.

8. The refuse vehicle of claim 7, wherein the second selectable element is the first selectable element.

9. The refuse vehicle of claim 5, the control system is configured to operate, responsive to a third operator acknowledgement, the first actuator, the second actuator, and a third actuator of the grabber assembly to complete a third operation.

10. The refuse vehicle of claim 9, wherein the third operation comprises:
operating the first actuator to retract the grabber assembly towards the body;
operating the third actuator to raise the grabber assembly towards a top portion of the body and deposit contents of the refuse container into the body and subsequently lower the refuse container;
operating the first actuator to extend the grabber assembly towards the position of the refuse container; and
operating the second actuator to release the refuse container from the grabber assembly.

11. A grabber assembly for a refuse vehicle, comprising:
a plurality of actuators;
a sensor configured to generate sensor data indicative of a position of a refuse container;
a user interface; and
a control system communicably coupled to the sensor and the user interface, the control system configured to:
determine, based on the sensor data, an operation of the grabber assembly corresponding to at least one of the refuse container or an obstacle proximate to the refuse container;
present, via the user interface, an indicator of the operation comprising a request for an operator acknowledgement of the operation;
receive the operator acknowledgement of the operation; and
operate, responsive to receiving the operator acknowledgement, the plurality of actuators of the grabber assembly to complete the operation.

12. The refuse vehicle of claim 11, wherein operation of the plurality of actuators cause an adjustment of a distance between a first grabber arm and a second grabber arm of the grabber assembly.

13. The refuse vehicle of claim 12, wherein the distance between the first grabber arm and the second grabber arm is a distance between a fully open state and a fully grasped state of the grabber assembly.

14. The refuse vehicle of claim 12, wherein the distance between the first grabber arm and the second grabber arm is based on at least one of (a) a width of the refuse container or (b) a distance between the refuse container and the obstacle.

15. The refuse vehicle of claim 11, wherein the operation comprises a first operation to operate a first actuator of the plurality of actuators to extend the grabber assembly to the refuse container.

16. The refuse vehicle of claim 11, wherein the operation comprises a second operation to operate a second actuator of the plurality of actuators to cause a pair of grabber arms of the grabber assembly to grasp the refuse container.

17. The refuse vehicle of claim 11, wherein the operation comprises a third operation to operate a third actuator of the plurality of actuators to raise the grabber assembly to deposit contents of the refuse container into the refuse vehicle.

18. A method for refuse collection by a refuse vehicle comprising a grabber assembly, the method comprising:
determining, by a control system of the refuse vehicle and based on sensor data generated by a sensor coupled to at least one of the refuse vehicle or the grabber assembly, an operation of the grabber assembly corresponding to at least one of a refuse container or an obstacle proximate to the refuse container;
presenting, by the control system and via a user interface of the refuse vehicle, an indicator of the operation comprising a request for an operator acknowledgement of the operation;
receiving, by the control system, the operator acknowledgement of the operation; and
operating, by the control system and responsive to receiving the operator acknowledgement, an actuator of the grabber assembly to complete the operation.

19. The refuse vehicle of claim 18, wherein aligning the grabber assembly with the refuse container comprises adjusting a distance between a first grabber arm and a second grabber arm of the grabber assembly.

20. The refuse vehicle of claim 19, wherein the distance between the first grabber arm and the second grabber arm is a distance between a fully open state and a fully grasped state of the grabber assembly, and wherein the distance between the first grabber arm and the second grabber arm is based on at least one of (a) a width of the refuse container or (b) a distance between the refuse container and an obstacle proximate the refuse container.
